(19) United States
(12) Patent Application Publication
(10) Pub. No.: US 2020/0065684 A1
(43) Pub. Date: Feb. 27, 2020

(54) SYSTEMS AND METHODS FOR REVERSE HYPOTHESIS MACHINE LEARNING

(71) Applicant: Parag Arun Kulkarni, Pune (IN)

(72) Inventor: Parag Arun Kulkarni, Pune (IN)

(21) Appl. No.: 16/672,430

(22) Filed: Nov. 1, 2019

Related U.S. Application Data
(63) Continuation of application No. PCT/IN2018/050270, filed on May 1, 2018.

(30) Foreign Application Priority Data
May 1, 2017 (IN) 201721015319

(51) Int. Cl. G06N 5/04; G06N 10/00; G06N 20/00

(52) U.S. Cl. CPC G06N 5/042; G06N 5/046; G06N 20/00; G06N 10/00; G06N 5/048

(57) ABSTRACT

Systems for creating a reverse-hypothesized network, said system comprising: data inputter for inputting input data, said data residing on nodes; context determination mechanism for identifying a context for each node; node identifier for identifying a node of disagreement, per nodes' set; stimulus inputter for adding stimulus data to said formed nodes' set to identify changes in nodes' parameters and network linkages in order to differentiate said forward hypothesis nodes and corresponding forward hypothesized nodes' set from said reverse hypothesis nodes and corresponding reverse hypothesized nodes' set, thereby providing inputs for obtaining an uncertainty index; uncertainty determination mechanism; freedom index determination mechanism; creativity index determination mechanism; and output mechanism for providing an output which is a vectored reverse-hypothesized node, output being a function of creativity index, creativity index being a function of uncertainty index and freedom index.

### RELATED APPLICATIONS

This application claims priority under 35 U.S.C. § 120 to, and is a continuation of, co-pending International Application PCT/IN2018/050270, filed May 1, 2018 and designating the US, which claims priority to Indian Application 201721015319, filed May 1, 2017, such IN Application also being claimed priority to under 35 U.S.C. § 119. These IN and International applications are incorporated by reference herein in their entireties.

### BACKGROUND

Machine learning is referred to methods and techniques to make machines intelligent. It provides computers with an ability to learn without being explicitly programmed. Machine learning focuses on the development of computer programs that can change when exposed to new data. Evolved from the study of pattern recognition and computational learning theory in artificial intelligence, machine learning explores the study and construction of algorithms that can learn from data. It also makes predictions on data—such algorithms overcome techniques those learn following strictly static program instructions by making data-driven predictions or decisions, through building a model from sample inputs.

The process of machine learning sits on top of data mining. Both systems search through data to look for patterns. However, instead of extracting data for human comprehension, as is the case in data mining applications, machine learning uses that data to detect patterns in data and adjust program actions accordingly. Machine learning algorithms are often categorized as being supervised or unsupervised. Supervised algorithms can apply what has been learned in the past to new data. Unsupervised algorithms can draw inferences from datasets.

Related techniques look for mapping between inputs and outputs and coming up with a pattern. This pattern is one major component for learning. This approach has limitations like linearity, failure to accommodate changes, and the like. However, in day-to-day life, there are many scenarios where uncertainty creates starting point for revelations. Even creativity is about coming up with something that is new, useful, and surprising or what is also colloquially known as ‘flash of a genius’.

Pattern-based learning never intends to come up with something new, useful, and surprising. Rather, it digs into heaps of past data to come up with pattern-based output which is similar and accurate. Such learning systems are termed as forward hypothesis learning systems.

### SUMMARY

Example systems and method creative reverse-hypothesized networks including sets of nodes that are groups of context-relevant nodes each including data and parameters resident on the node using marked and considered events Example embodiments may include computer hardware and software configured to receive input data residing on the nodes, identify a context for each node, group the nodes to form a set of nodes for each context, identify a node of disagreement in the set of nodes by identifying a difference in context-relevance for each set of nodes, add stimulus data to the set of nodes to identify changes in parameters and network linkages in the set of nodes to differentiate forward hypothesis nodes and a corresponding forward hypothesized set of nodes set from reverse hypothesis nodes and a corresponding reverse hypothesized set of nodes, thereby providing inputs for obtaining an uncertainty index, compute the uncertainty index for each set of nodes, compute a freedom index for each set of nodes, compute a creativity index for each set of nodes as a function of the computed uncertainty index and the computed freedom index, wherein the creativity index is a function of the uncertainty index and the freedom index; and output a vectored reverse-hypothesized node, a vectored reverse-hypothesized set of nodes, or a vectored reverse-hypothesized network of sets of nodes, as a function of the creativity index. The output may be is a vector-weighted, uncertainty-weighted, freedom-weighted, and, therefore, creativity-weighted reverse-hypothesized network of nodes and, therefore, a reverse-hypothesis output.

### BRIEF DESCRIPTION OF THE DRAWINGS

Example embodiments will become more apparent by describing, in detail, the attached drawings, wherein like elements are represented by like reference numerals, which are given by way of illustration only and thus do not limit the terms which they depict.

FIG. 1 illustrates compromise lines and nodes of disagreement.

FIG. 2 illustrates a schematic of a reverse hypothesis machine.

FIG. 3 illustrates architecture for the system.

FIG. 4 illustrates a Learning Map.

FIG. 5 shows mapping between Intelligent Agents and associated Learning Maps for collective learning.

FIG. 6 depicts concept of decision node and context-relevant neighbor nodes.

FIG. 7 depicts the concept of meta-context with reference to decision nodes and context-relevant neighbor nodes.

FIG. 8 illustrates a context-relevant neighbor node and mapping to context vectors.

FIG. 9 depicts context relationship diagram.

FIG. 10 illustrates a Context Determination mechanism.

FIG. 11 illustrates a flowchart for example methods.

### DETAILED DESCRIPTION

Because this is a patent document, general, broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two elements, including intermediary devices, networks, etc., connected wirelessly or not.

As used herein, the singular forms “a,” “an,” and the are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

As used herein, a “node” may be a networked environment. In a communications network, a “node” or a “network node” is a connection point that can receive, create, store, or send data along distributed network routes. Each network node has either a programmed or engineered capability to recognize, process, and forward transmissions to other network nodes. Each network node, also, has either a programmed or engineered capability to form connections with other nodes so as to form a new network based on pre-defined parameters such as a ‘context’. Illustrative embodiments preferably are implemented on a conventional computer network. Among other things, a network includes at least two nodes and at least one link between the nodes. Nodes can include computing devices and routers. Nodes can also include link establishment mechanisms and protocols. Nodes can also include encoders and decoders. Nodes can also include switches. Nodes can also include transmitters, receivers, and transceivers. Nodes can be implemented in software in combination with hardware or as a virtual machine, or using network function virtualization. Nodes communicate via networks according to protocols, such as the well-known Internet Protocol (IP), Transmission Control Protocol (TCP), and the like.

As used herein, “network” is an interconnected group of nodes. Interconnections may be wired or wireless. Therefore, these networks can be physical or virtual. More importantly, these networks are not fixed in their topography or their interconnections. Example embodiments describe how the nodes align or connect or communicably couple with each other to form a new network, in order to obtain an output that is a function of reverse hypothesis.

As used herein “hypothesis” is defined as a defined link or a defined relationship between nodes. “forward hypothesis” is defined as a presumptive link or a presumptive defined relationship between nodes, the presumption being based on statistical data or statistical evidence, empirical data or empirical evidence, rule-based data or rule-based evidence, pattern-based data or pattern-based evidence, and the like data or evidence. “Reverse hypothesis” is defined as a pre-emptive link or a pre-emptive defined relationship between nodes, the pre-emption being based on uncertainty index and freedom index. Uncertainty Index defines and gives an indication of possibility of an occurrence or an outcome vis-à-vis an input-based or an input-defined or an input-aligned formed network(s) of nodes. Freedom Index defines and gives an indication of impact of an outcome across a vis-à-vis an input-based or an input-defined or an input-aligned formed network(s) of nodes. Example embodiments include ‘reverse hypothesis’ networks. Thus, while a forward-hypothesized network of nodes focuses on patterns and rules, a reverse-hypothesized network of nodes focuses on exploiting uncertainty and impact points in a network.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

The Inventor has newly recognized that traditional learning, based on mapping input and output, is data intensive and demands data for learning. Forward hypothesis learning is not suitable where there is creativity involved, where there is intent to solve different problems with dynamic behavior and exhibiting uncertain outcomes. Basically, these methods can be termed as knowledge acquisition-based learning approaches. Though different systems and methods came in picture the paradigm of all these approaches is about knowledge acquisition. These knowledge acquisition-based approaches—which is referred as forward hypothesis machines. Forward hypothesis machines are very popular and handle many important machine learning challenges. But when looking for creativity knowledge acquisition, paradigm does not support it. There is a need of transition from knowledge acquisition paradigm to knowledge innovation paradigm. This is called a Reverse Hypothesis Machine.

Reverse Hypothesis Machines approach learning all together from different perspective. They exploit the uncertainty points. While forward hypothesis machines are about minimizing the uncertainty, reverse hypothesis machines use uncertainty for learning. Creativity is about producing something new, useful and surprising. The Reverse hypothesis machines stress finding freedom points and associating it. The detailed context comes in picture only at later stage when it comes to detection of the best possible option in the context of the problem. Context vector machine finds out the context boundaries and can also be used to combine more than one context when necessary. Too much data is detrimental; so is too little data. Reverse Hypothesis Machines find optimal data required, using optimal learning and knowledge innovation-based learning to learn creatively and come up with solutions those are new, surprising and relevant.

Finally, it is learnability that matters and hence, knowledge innovation-based learning is measured not in terms of accuracy but learnability. Reverse Hypothesis Machines are not about compromise and consensus—but it is rather disagreement and association. While Forward hypothesis machines works on reducing boundary conditions Reverse Hypothesis Machines exploits boundary conditions and associate uncertainty points. Hence the diversity and independence contribute to Reverse Hypothesis Machines.

Example embodiments may thus provide a system and method that provides for reverse hypothesis learning using uncertainty and surprises, provide a system and method which further provides mining data and forming learning maps, graphical representation based on uncertainty and learning opportunities, ranking with reference to context, provide a system and method for building learning maps corresponding to association among various learning points in the system and method, provide a system and method which provides for creating machine learning and solving problems that are beyond patterns and typically called creativity problems, provide a system and method that can identify uncertainty points to expand conceptual space, provide a system and method to be used where creativity is involved in problem solution approach and where output is new, useful, and surprising, provide a system and method with learning ability and ability to improve, measure, and track learnability, provide a system and method for learning based on non-pattern data elements or boundary data elements, learn maps and solution for problems where demand is to produce solutions those are novel, useful and surprising, provide a system and method which can integrate and utilize all learning components, provide a system and method intended to use reinforcement, co-operative and collaborative learning base for enhancing learnability of the system, provide a systemic association between uncertainty and pattern with appropriate context. Such example embodiments described below address these and other problems recognized by Inventor with unique solutions enabled by example embodiments.

The present invention is reverse-hypothesized networks and methods of creating and using the same. In contrast to the present invention, the few examples discussed below illustrate just a subset of the variety of different configurations that can be used as and/or in connection with the present invention.

Example embodiments and methods provide a reverse hypothesized network, including an area of machine learning, where the system learns from data which is not defined or seen in patterns but exhibits uncertain and unpredictable behavior.

Specifically, this example embodiments are for a system and method for building learning maps corresponding to association among various learning points in a networked environment including nodes.

While machine learning is striving for Forward Hypothesis based on mapping, reverse hypothesis tries to decode mapping and relationships and uses uncertainty points for exploring new pathways. Basically, forward hypothesis paradigm does not support nurturing creativity and precisely targets minimizing uncertainty to achieve repeatable or safe results. This is basically knowledge acquisition driven paradigm. Here, it accumulates data and based on algorithm and works within the predefined conceptual space that is confined while learning. When working is predefined but in a large conceptual space, a certain level of accuracy is guaranteed. Obviously, going beyond given conceptual space results in heavy reduction in accuracy; but may be required to achieve creative results or hitherto unknown. Since the objective, of this example embodiments are to use reverse hypothesis networks to achieve learnability and creativity and not mere accuracy, there is a need to go beyond conceptual space.

In at least one exemplary non-limiting embodiment, this system and method can be explained in context of a health care system.

Typically, health care systems, value chains, and parameters are complex and depend on many associative parameters. Right from a patient's history, place, social and family context to his/her past medication builds a context. Example embodiment systems identify uncertainty points in this context. The reverse hypothesis machine begins with most uncertain points in these associations to come up with learning opportunities, where ‘uncertainty points’ may be a typical non-significant change in the behavior of the patient which has limited impact on outcome at a given point of time. According to ‘forward hypothesis’, a network of nodes is formed where direct relationships are established to predict prognosis of the patient based on similarity of parameters of other such patients, the parameters being demographic, disease, effect over degrees of separation, and the like. According to ‘reverse hypothesis’, a network of nodes is formed where causality is not a function of just similarities of parameters; rather, causality is learnt over a period of time based on based on context mapping and checking for outcomes and based on non-linear models beyond known degrees of freedom/separation.

The output is a vector-weighted network of nodes, aligned and/or synchronized, in accordance with the reverse-hypothesis method. In at least another embodiment, the output is a determinant vector-weighted, probability-weighted, uncertainty-weighted, freedom-weighted, and therefore, creativity-weighted set of network of nodes (with resident data elements).

A network topology mapping mechanism maps a network topology. The topology includes nodes which may be interconnected.

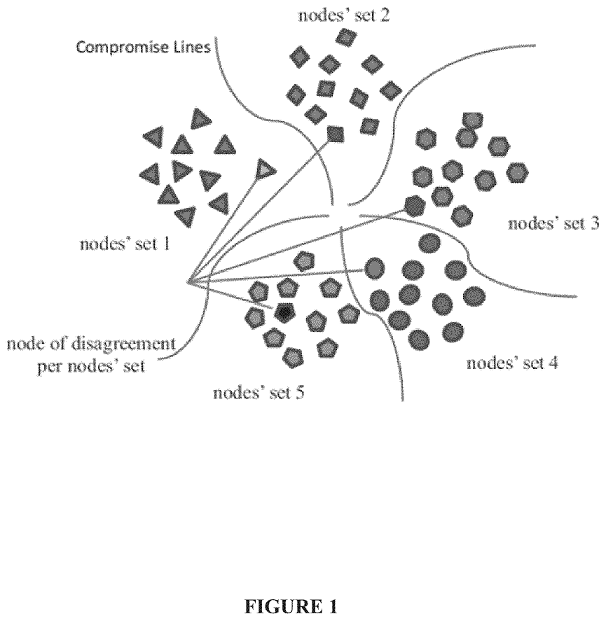

FIG. 1 illustrates compromise lines and nodes of disagreement.

Forward hypothesis works for agreement and consensus, reverse hypothesis exploits disagreement.

Therefore, a network of nodes is distributed into groups of nodes based on identified parameters of each node so that a set of nodes exhibiting similar properties as determined by an identified parameter are grouped together. A nodes' set 1 is a group of nodes with a common identified parameter or a group of parameters. A nodes' set 2 is a group of nodes with another common identified parameter or a group of parameters. And so on and so forth, a multiplicity of groups of nodes (nodes' set 1, nodes' set 2, nodes' set 3, nodes' set 4, nodes' set 5) are defined. A compromise line, as illustrated, are partitions between these nodes' sets. In each of these nodes' sets, a node of disagreement is determined. In at least an embodiment, this node of disagreement is the node having the least relevance in terms of commonality based on identified parameter.

One entire network including a plurality of networked nodes' set may be considered as one learning map. Many such learning maps may be formed to allow example embodiment systems to perform.

Each of these nodes depicts a specific behavior based on input data. Thus, when data is input, a nodes' set or a network or nodes is formed accordingly to create a reverse hypothesized network and, accordingly, a reverse hypothesis output is obtained.

Each of these nodes or nodes' set or network of nodes provide a creativity index, an uncertainty index, and a freedom index. Each of these indexes are utilised to determine the configuration of nodes to create a reverse hypothesized network and, accordingly, a reverse hypothesis output is obtained.

Each node includes data residing on it which is pre-processed once it enters the node in order to convert the node into a vector including data along with parameters affecting that data and hence affecting the node. Further processing of the node determines its context. Further processing of the node determines its context. Further processing of the node determines its context-relevant neighbor node for purposes of alignment or grouping into a context-relevant nodes' set. Further processing of the node determines its creativity index. Further processing of the node determines its freedom index. Further processing of the node determines its uncertainty index.

A node of disagreement, in a nodes' set, may be determined by identifying difference in context-relevance per node set. In other words, the least relevant context-relevant node is termed as a node of disagreement for that nodes' set.

Example embodiments may include a context determinator configured to determine a context for each node based on data residing on the node. In at least one embodiment, a context determination can be enabled by means of sensors in a contextual environment. In at least one other embodiment, a context determination may be enabled by means of user-input context data in a contextual environment. In at least one other embodiment, a context determination may be enabled by means of an administrator-enabled context data in a contextual environment. Determination of context and application of context is defined in co-owned US patent publication 2015/0206070 to Kulkarni, published Jul. 23, 2015, and incorporated herein by reference in its entirety.

Input data can be divided into marked events and considered events which form nodes.

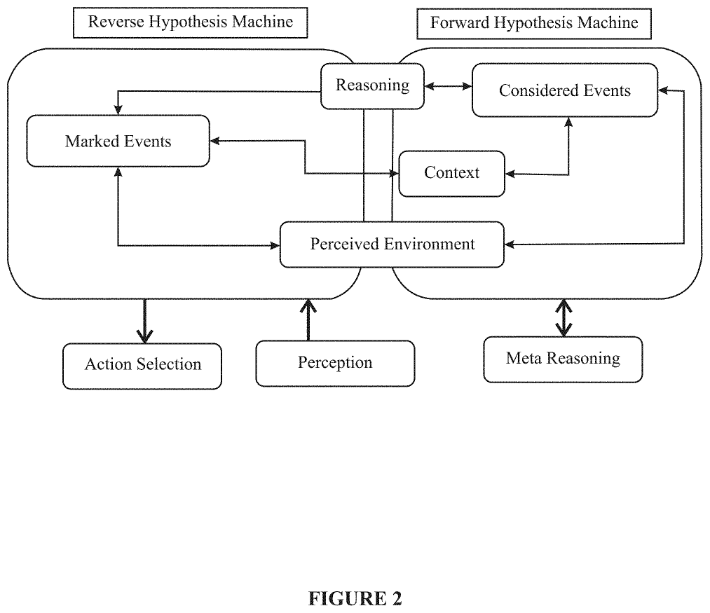

FIG. 2 illustrates a schematic of a reverse hypothesis machine.

The block, reasoning block, relates to determination of reasoning or links between the marked events and considered events. Reasoning provides justification, in that, weight assignment between such links is done as per identified reasoning. The output of a reasoning block can be uncertainty events which form the basis of reverse hypothesis nodes (explained further in the specification) and which are mutually excluded from marked events (which are forward hypothesis nodes).

The block, considered events' block, relates to events (and therefore, inherent data items correlating with nodes) which have heighted uncertainty index. Analysis of these events provides new pathways of learning causality between nodes. This introduces dynamicity.

The block, context, relates to any situation or components which add weightage to the nodes or network or nodes or links between nodes. In other words, context explains a scenario of environment and agents.

The block, perceived environment, is a context-relationship based network of nodes depicting an event and connected environment. Typically, it is a filter which takes actions and provides responses with reference to a context obtained from an environment of current events.

The block, meta-reasoning, relates to providing reasoning for reasons. In other words, this block provides a context for taking actions and for providing responses. Relationships or linkages between nodes are analyzed in relation to these meta-reasons or contexts.

The block, perception, relates to an external stimulus (add-on event or add-on data) to the linked network of nodes. Behavior of the network of nodes, based on stimulus, is captured or ‘perceived’ to outline causality as a function of goals.

The block, action selection, relates to a process for selection of an action. E.g. action could be ‘knowing’ what a crown thinks about a product, how a crowd may vote, and the like.

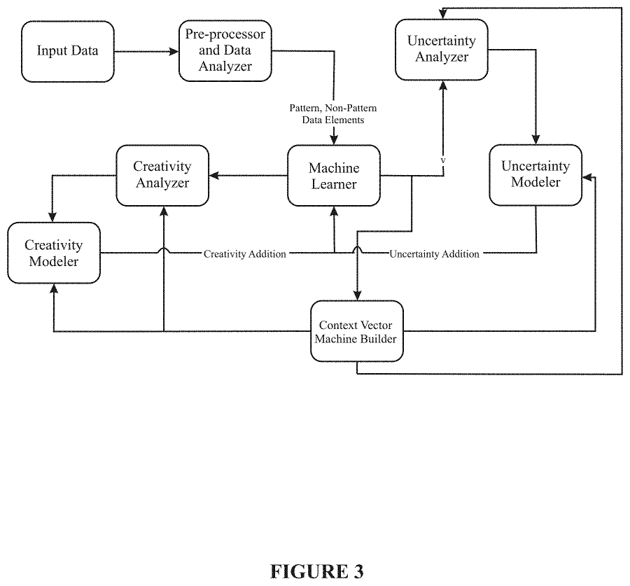

FIG. 3 illustrates architecture for example embodiment systems.

An example embodiment system may consider at least one of two approaches: one is finding pattern from input data and the other is finding non-pattern from input data. In other words, the system (after a pre-processor pre-processes input data) identifies nodes (called “forward hypothesis nodes”) which conform to pre-defined rules and/or patterns and further identifies nodes (called “reverse hypothesis nodes”) which do not conform to the pre-defined rules and/or patterns. This is done by means of a data analyser which analyses data residing on the network nodes. These pattern elements in data are passed directly to a machine learner as training data set which gives output as Y for input data of X.

Y=f(X)

Where X is input and Y is output.

But in some cases, the reverse hypothesis node (due to their unknown input data or surprising input data or non-rule data or non-pattern data) can cause system failure. The machine learner is configured to learn from such failures as to the data. The creative learning works under deliberate additions of new data sequence, thereby adding new nodes with new data. The system uses the non-pattern inputs (i.e. reverse hypothesis nodes) and attempts to find a learning component as new sequence of learner or to gain pattern in uncertainty.

In reverse hypothesis, uncertainty finding is a major task. Uncertainty can be defined as small non-regular events; it has indicators which are not easy to decode and if it is magnified, the prior art systems do not have a solution to counter it in their present state. However, uncertainty occurs in dynamic environments.

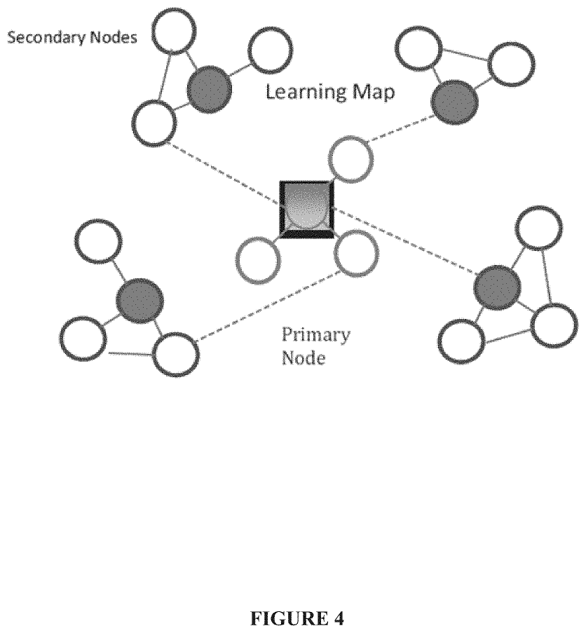

FIG. 4 illustrates a Learning Map. This learning map includes Primary Nodes and Secondary Nodes.

An aligner identifies and aligns directions for selection of a learning strategy in the mapped networked topology. Fixed structured graph can be used for representing learning maps and causal inference between networked nodes. This can even be aligned using multiple-concept graphical model. The multiple-concept graphical models drive an action. A learning map association through graphical model is depicted in FIG. 4. Meta-Reasoning is employed to determine uncertainty index. Meta-Reasoning refers to processes that monitor progress of reasoning and problem-solving activities and regulate the time and effort devoted to them. In other words, Meta-Reasoning records association between nodes and outputs of nodes' sets or network of nodes' sets along with feedback to determine quantum of uncertainty in the manner of an uncertainty index. Monitoring processes are usually experienced as feelings of certainty or uncertainty about how well a process has, or will, unfold. An uncertainty index determination mechanism is employed to determine this uncertainty quantum. Uncertainty index is an index, which finds difference between amount of change in linkages and vector parameters of nodes and/or nodes' set and/or network of nodes in response to marked events. In other words, changes in network linkages and nodes' weight is observed for a forward-hypothesized network for same input data and/or stimulus data when compared with changes in network linkages and nodes' weight is observed for a reverse-hypothesized network for same input data and/or stimulus data; to obtain an uncertainty index.

Thus, there may be multiple such learning maps so that multiple scenarios can be envisaged along with corresponding uncertainty indices.

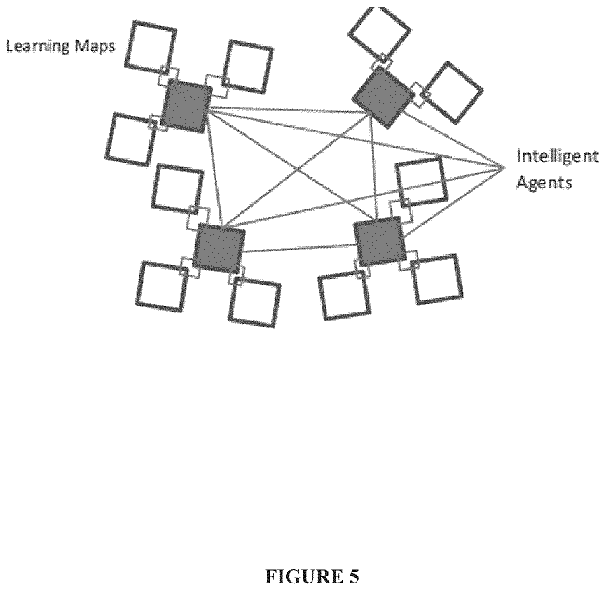

FIG. 5 shows mapping between Intelligent Agents (IA) and associated Learning Maps (LM) for collective learning.

Example embodiments may include a freedom index determinator which determines a freedom index for each node. Every node has a freedom index; it has correlation score with reference to other corresponding nodes in another learning map (another nodes' set). The difference between knowledge acquisition and collaborative learning is that, in collaborative learning process an intelligent agent collaborates to find out a right way of learning and improvement.

Freedom index typically possibility of multiple solutions
Freedom α uncertainty
Freedom α (1/context)

As per Welch Satterthwaite equation effective variance is given by

$$v ≡ \frac{{( \frac{{s}_{1}^{2}}{{N}_{1}} + \frac{{s}_{2}^{2}}{{N}_{2}} )}^{2}}{( \frac{{s}_{1}^{4}}{{N}_{1}^{2} {v}_{1}} + \frac{{s}_{2}^{4}}{{N}_{2}^{2} {v}_{2}} )}$$

$${v}_{eff} = \frac{{u}_{c ( y )}^{4}}{{\sum }_{i = 1}^{n} \frac{{c}_{i}^{4} {u}_{{x}_{i}}^{4}}{{v}_{i}}}$$

Here, n is number of observations—here in our case we will take n is number of possible routes observed and Vᵢ=n−1. This can be mapped to determine uncertainty and freedom index.
1. Find key nodes of uncertainty—Associate different uncertainty nodes
2. Use reverse hypothesis with maximum uncertainty
3. Introduce slowly more uncertainty points
4. In crowd sourcing contributors will not provide data, knowledge or information but uncertainty points
5. Expand conceptual space with increase in uncertainty
6. That will create more uncertainty and may result in shift in uncertainty centroid

A creativity index determination mechanism is configured to compute creativity for a determined set of nodes. Creativity index is determined based on freedom index and uncertainty index. In other words, a creativity index is determined based on uncertainty and association (or impact) with actions.

Therefore,

Creativity index=C*(Freedom Index of new traversed node*change in Uncertainty Index)

Here C is creativity indicator.

The creative learning or, specifically, the system and method of this example embodiments are about learning and coming up with outcomes or outputs with a high creativity index (surprising options) and building ability to measure learnability. These options can be represented as graphs built by the representation mechanism. These multiple graphs can be combined and associated—and the learnability measurement allows selecting the option. More than one learning map continues and comes up with options for learning.

Creativity index can be a function of uncertainty index and/or a function of freedom index as it finds association with action performed for events, which helps generate uncertainty matrix using creativity index.

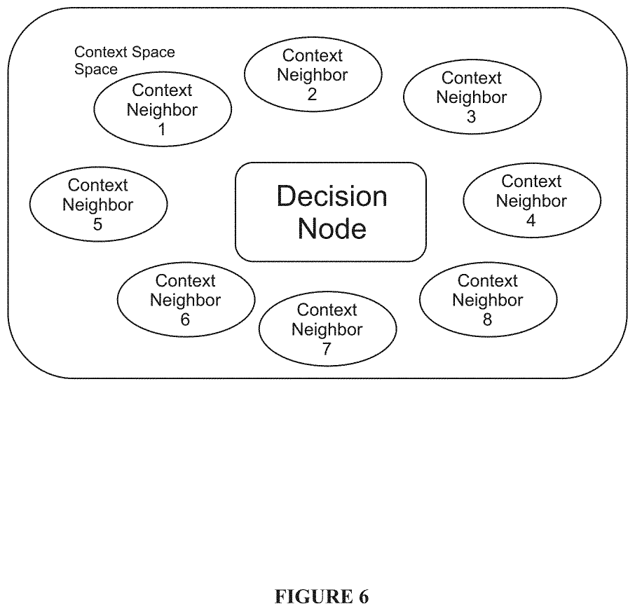

FIG. 6 depicts concept of decision node and context-relevant neighbor nodes (1, 2, 3, 4, 5, 6, 7, 8).

Example embodiments may include a decision node determination mechanism.

When context vector is applied, a decision node and its context-relevant neighbor node plays a key role in learning. Context-relevant neighbor nodes are the nodes with same context with different freedom indices. There are multiple context-relevant neighbors of the decision node. The freedom indices and possible path of context neighbors also contribute to decision-making.

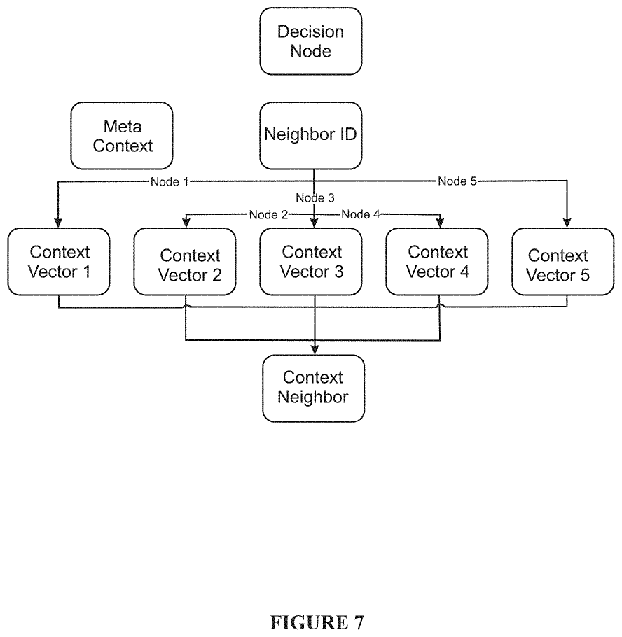

FIG. 7 depicts the concept of meta-context with reference to decision nodes and context-relevant neighbor nodes. Using meta-context found for every event, it tries to explore nearest neighboring nodes and action performed for the events. By relative context found in neighbor node, it generates context vectors of neighbor nodes which is used for uncertainty-based learning.

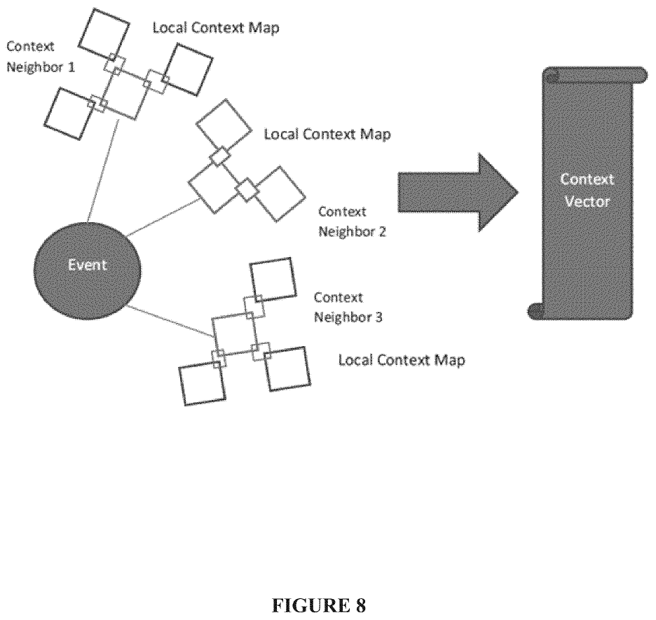

FIG. 8 illustrates a context-relevant neighbor node and mapping to context vectors. The context-relevant neighbor nodes contribute to context and that help in building a context vector for the entire nodes' set. The process of mapping this context to context vector is depicted in FIG. 8.

In accordance with another example embodiment, there is provided a context-relevant neighbor determination mechanism. This enables in identification and verification of a context-relevant neighbor node.

The decision node is a prime node responsible for decision and it is associated with different nodes. A context-relevant neighbor node is a directly associated node with decision node in the context of the problem (input data). It is determined using context vector machine.

In accordance with another example embodiment, there is provided a context vector machine. Context vector machine represents a method for context-relevant classification. The context vector stands for a vector that determines context boundary. Again, there are issues like boundary conditions, huge dimensionality, and also dynamic context variations. While typical vectors are about separating two regions, context vector is intelligent vector representation that deals with dynamic region. Dynamic vector gives variable fuzziness in either direction with reference to given context. While support vector machines and similar techniques support crisp classification—context vector machine goes for fuzzy classification. It is multi-class mapping with fuzzy classification.

Identifying contexts are shown as follows:

C={c1,c2, . . . ,cn}

Cₚ is context of the problem
Cₚ is close to one of the possible contexts but can be associated with more than one context. The most dominant context decides the direction of decision but other contexts also play role in overall context determination. Context vector machine tries to find vectors representing the context boundaries. These vectors allow to find out association between two nodes with reference to context. This helps in identifying the context neighbors. The multiple context can be combined with reference to association where relationship between two contexts is measured in terms of distance. This allows to combine two or more contexts.

In at least one embodiment, the context relationship is represented by graph.

Particularly, in FIG. 8, an Event is associated with:
Local Context Map 1 including Context Neighbour 1;
Local Context Map 2 including Context Neighbour 2;
Local Context Map 3 including Context Neighbour 3;
   . . . and the like in order to obtain Context Vector.

For each event, as explained in FIG. 7, the system and method generates context vectors for neighbor nodes using the meta-context and decision nodes. For generating context for neighbor nodes, a local context is found for each neighbor node within a nodes' set or a network of nodes. By associating multiple context neighbor nodes with event, example systems and methods provide a context vector for that nodes' set or network of nodes. E.g. students' personal data and academic data are two different contexts. These have different local maps like location, body measurement, and the like. as a personal local map. Another is an academic map which includes marks, awards, and the like. If event is related to strategic sports like football, the context vector can be drawn to find out depending on association between these two context neighbors.

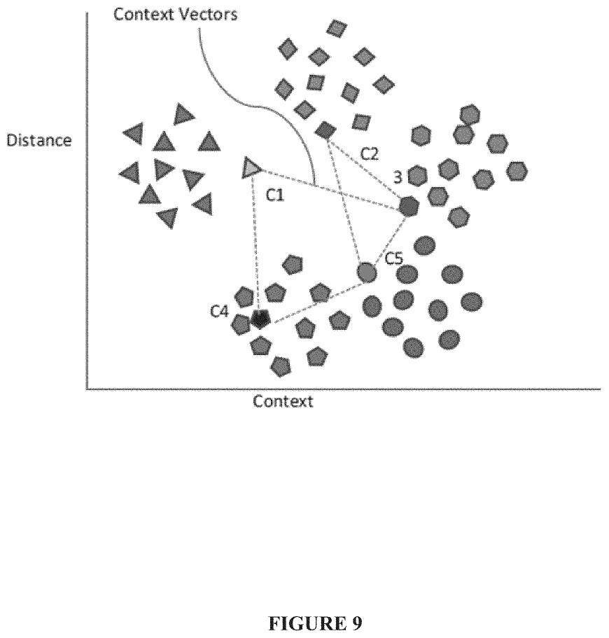

FIG. 9 depicts context relationship diagram. Particularly, in FIG. 9, context vectors are plotted on FIG. 1 to identify nodes of disagreement.

According to a non-limiting exemplary embodiment of dominant context, while there are many small and ancillary factors impacting on classification and decision making, there is always one or two major situational aspects dominating overall proceedings. These dominating aspects take lead in determining overall context.

Context can be location, place, time, situation, or the like. It is determined based on supporting data of the situation. A context vector is expected to represent the boundaries of this situation. When multiple contexts are combined, boundaries get expanded. According to a non-limiting exemplary embodiment, a person tries to buy a particular entity. Selection of this entity may depend on his or her context; in selection of garment, context may be place, date, weather, occupation, and/or the like parameters.

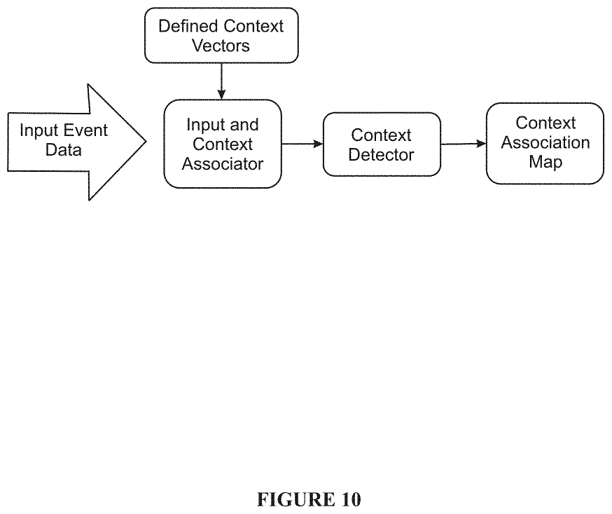

FIG. 10 illustrates a Context Determination mechanism.

Model of context vector is described below:

Let context be function of place, time, date, weather, environment, situation, and/or the like parameters.

Context=F{place,time,date,environment,S₁,S₂, . . . ,Sₙ}

Here S₁, S₂, . . . ,Sₙ represent situation parameters. These are based on situation.

Context vector is represented as multi-level matrix on time scale.

$$[ \begin{matrix}{S}_{11} & … & {S}_{1 n} \\ ⋮ & & ⋮ \\ {S}_{n 1} & … & {S}_{nn}\end{matrix} ] ↔ [ \begin{matrix}{T}_{11} & … & {T}_{1 n} \\ ⋮ & & ⋮ \\ {T}_{n 1} & … & {T}_{nn}\end{matrix} ] ↔ [ \begin{matrix}{U}_{11} & … & {U}_{1 n} \\ ⋮ & & ⋮ \\ {U}_{n 1} & … & {U}_{nn}\end{matrix} ]$$

The multiple context vectors are combined to form representative context vector. The idea of context vector is assessing the context and finding relevance of that context to find context neighbor. Reverse Hypothesis Method use this context effectively while selecting most relevant option from creative solutions. Context vector can further be used for multi-class classification. The context vectors can be used for creative association. This allows to combine two or more selected creative outcomes resulted through Reverse Hypothesis Method. This creative association tries to find out mutual relationships using context vector machine. In this case other methods like greedy method or statistical methods can also be used. Thus, reverse hypothesis machine allows learning to produce creative options and those can be consumed as per context.

In FIG. 10, the following methodology is described:

Data is input to nodes;

Nodes are grouped as per compromise vectors, each group having at least a node of disagreement;

Context is detected to obtain context vectors;

Nodes of disagreement are determined per group of nodes using obtained context vectors;

Context association map is output

Example embodiments and methods associate parameters coming from different data sources and determines context-relevant association among uncertainty maps. According to a non-limiting exemplary embodiment, this can be elaborated from an event perspective:

Input Events:

I={i₁,i₂,i₃, . . . iₙ}

### Simple Clustering Forms Clusters:

C={c₁,c₂,c₃, . . . ,cₙ} where obviously n<<m

Here i₁ to iₙ are representative inputs derived after time series discretization, weight mapping, and other averaging mechanism. These input are representative inputs and typically it is mapping between standard inputs and outputs.

There are clusters with different number of entities in it. The smallest cluster can be treated as creativity enhancer. In this typical learning process, limited context is provided in the beginning and the system comes up with solutions. More contexts are provided at a later stage. Creative learning is not just about method but also about learning policy.

Example embodiment system are capable of three properties:

1. Creativity—departure from routine with ability to produce useful but surprising results;
2. Optimality—Use of optimal data, optimal resources and building optimal solutions; and
3. Learnability Higher learnability and hence build ability to come up with interesting solution in new scenarios, handle different scenarios.

The combination of Forward Hypothesis Machine and Reverse Hypothesis Machine is something that can get best of both worlds. These are combined by means of systemic machine learning. Here, in this case, associated systems are looked at and uncertainty is introduced in sub-system based on need of problem. Here, systems working on Forward Hypothesis Machine and Reverse Hypothesis Machine collaborate to fetch results those are creative as well as immediately usable. These are called as Collaborative Hypothesis Machines (CHM). Collaborative Hypothesis Machines works on three principles

Limited Exploitation;

Higher Exploration;

Introduction of Creativity.

Data creates bias and, with multi agent systems, this bias is reduced to improve creativity of Reverse Hypothesis Machine. The collaborative Reverse Hypothesis system and method thus exhibits improved creativity and learnability at partial data. It further optimizes context to improve results. The context optimality is about going for optimal context. As the system and method goes on reducing uncertainty, the context parameters become strong and at optimal context Reverse Hypothesis system and method produce exceptionally good results—it is known as optimal context point. Data Associativity plays the role during evaluation of creative solutions in case of Reverse Hypothesis system and method. This paradigm is about Exploiting randomness; since randomness increases range of solutions. As discussed, that Reverse Hypothesis system and method allows following the different paths and learning creatively producing surprising results. Reverse Hypothesis system and method exploits randomness and limited context scenarios and hence learning maps to behaviors and not outcomes.

Example method for creating a reverse hypothesized network include:

1. Identify learning space
2. Locate creativity space vide creativity index;
3. Locate uncertainty points vide uncertainty index;
4. Select uncertainty points for creativity;
5. Calculate freedom index;
6. Provide an output which a vectored node or a vectored nodes' set or a vectored network of nodes with is a function of a creativity index, the creativity index being a function of the uncertainty index and the freedom index.

Most of the time, uncertainty index provides an index of events that are unlikely to occur. On a rationality scale, each event may have equal probability. The more the uncertainty, the more is the likelihood of learning (of vectors of nodes and/or of links between nodes). Each learning component makes use of actions and responses (causality) performed by intelligent agents in the networked environment.

A higher uncertainty-based environment drives a larger freedom index which gives a lot of creativity factors and therefore, drives up creativity index. Such type of learning handles all scenarios that may occur in future in dynamic environments. So, due to learning of causality, there are improved or better learning happenstances and thereby produces better results than a forward hypothesized network. Such intelligence can perform better for dynamic environmental changes.

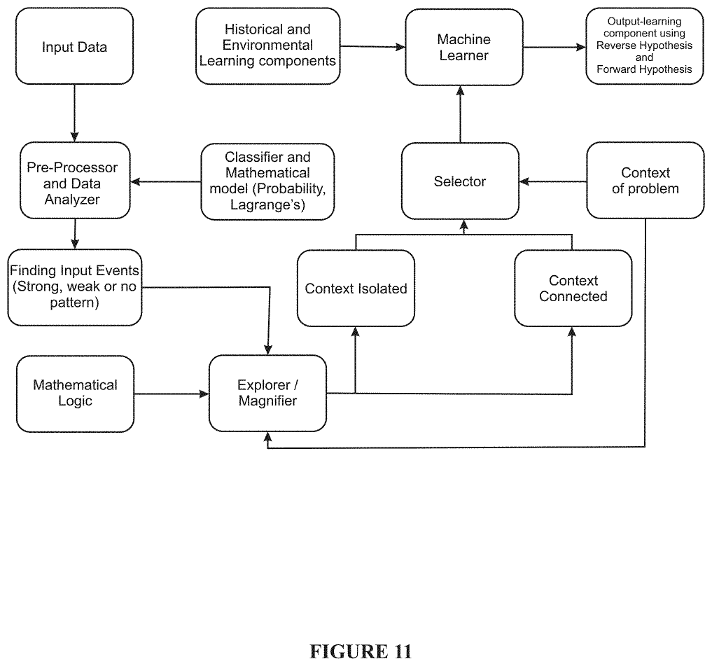

FIG. 11 illustrates a flowchart for example methods.

Exploration gives a possible logical path emerging from the source for each identified input (weak or no pattern events) and may have one or two logical and contextual output paths leading towards goal.

Learning for such path will be done by environmental and historical events (which are similar to current event) happened and possible outcomes of them. Example tsunami in Japan and its effect is learning component for any small change in wave.

The context vector build by forward hypothesis machine learning provides important but quite inherited information about the inputs. In order to build context for uncertainty, it is called extended context (for the reverse hypothesis nodes) which is inherited, predictive, and inferred context and which can be used to handle surprising or uncertain input data.

If a machine learning system which is evolved enough for providing good results, still sometimes, for certain inputs it is unable to produce the desired outputs. Deliberate introduction of uncertainty helps in such cases. These uncertainties can be generated by providing input data which helps to learn. These uncertainties definitely provide a new learning component while they also increase complexities. Another aspect is to select an uncertainty which is deliberate. Such uncertainties are selected by ranking uncertainty based on association of deliberate uncertainty to context vector machine.

This system includes extended context built on two methods:

1) incremental building on the exploration of each input for certain levels;

2) finding more relative context for uncertain elements.

Building extended context from uncertainty provides proper decision support for any predictive modeling. This system and method finds more learning components against traditional forward hypothesis machine learning.

Example embodiments include systems and methods for providing reverse-hypothesized network. Example embodiments may include, and example methods may use, computer processors, relays, servers, input equipment including keyboards and voice-recognition software, networks, and attendant memory and busses that are intentionally designed—that is, programmed—with functionality described herein, through both software and hardware configurations. As such, it is understood that devices like determination mechanisms, determinators, searchers, gatherers, inputters, outputters, feature/relationship identifiers, etc., includes computer-processor-driven devices appropriately-programmed or designed to perform the described functionality. Such devices may further include permanent and transient data storage as well as specific programming for the computer processor to execute their functions described above.

Example embodiments and methods thus being described, it will be appreciated by one skilled in the art that example embodiments may be varied and substituted through routine experimentation while still falling within the scope of the following claims. For example, although some computer architectures are used in the figures, it is understood that different networks are useable in example embodiments—and fall within the scope of the claims. Such variations are not to be regarded as departure from the scope of these claims.

What is claimed is:

1. A method for creating a reverse-hypothesized network including a set of nodes that is a group of context-relevant nodes each including data and parameters resident on the node using marked and considered events, the method comprising:
receiving input data residing on the nodes;
identifying a context for each node;
grouping the nodes to form a set of nodes for each context;
identifying a node of disagreement in the set of nodes by identifying a difference in context-relevance for each set of nodes;
adding stimulus data to the set of nodes to identify changes in parameters and network linkages in the set of nodes to differentiate forward hypothesis nodes and a corresponding forward hypothesized set of nodes set from reverse hypothesis nodes and a corresponding reverse hypothesized set of nodes, thereby providing inputs for obtaining an uncertainty index;
computing the uncertainty index for each set of nodes;
computing a freedom index for each set of nodes;
computing a creativity index for each set of nodes as a function of the computed uncertainty index and the computed freedom index, wherein the creativity index is a function of the uncertainty index and the freedom index; and
outputting a vectored reverse-hypothesized node, a vectored reverse-hypothesized set of nodes, or a vectored reverse-hypothesized network of sets of nodes, as a function of the creativity index.

2. The method of claim 1, further comprising:
identifying forward hypothesis nodes and links between the forward hypothesis nodes conforming to pre-defined rules and/or patterns; and
identifying reverse hypothesis nodes and links between reverse hypothesis nodes not conforming to the pre-defined rules and/or patterns.

3. The method of claim 1, further comprising:
adding stimulus data including learning, with a machine learner, a new sequence in the set of nodes, wherein the new sequence does not conform to the pre-defined rules and/or patterns so as to providing a forward-hypothesized set of nodes or a new sequence that do not conform to the pre-defined rules and/or patterns so as to generate a reverse-hypothesized set of nodes.

4. The method of claim 1, further comprising:
identifying and aligning a flow in linkages in the set of nodes, wherein the flow determines causal inference between nodes the set of nodes.

5. The method of claim 1, wherein, determining the uncertainty index includes determining the uncertainty index as correlative to meta-reasoning configured to record association between the nodes and outputs of the set of nodes with feedback to determine a quantum of uncertainty in terms of the uncertainty index.

6. The method of claim 1, wherein, the step of determining uncertainty index comprising a step of determining uncertainty index which is correlative to differences in amount of change in linkages and vector parameters of nodes and/or nodes' set and/or network of nodes in response to marked events.

7. The method of claim 1, wherein, the computing the freedom index includes a step of determining a correlation score of a node with corresponding nodes of a different set of nodes.

8. The method of claim 1, wherein, the freedom index is directly proportional to uncertainty and inversely proportional to context, wherein the creativity index is directly proportional to the uncertainty index and directly proportional to the uncertainty index, and wherein the creativity index is directly proportional to the freedom index.

9. The method of claim 1, wherein, context-relevant neighbor nodes are spaced apart from each other by different freedom indices.

10. The method of claim 1 wherein the network of nodes includes at least a decision node determined using a context vector machine that identifies a context-relevant neighbor node and a directly-associated node with the identified context-relevant neighbor node in the context of input data.

11. The method of claim 1, further comprising:
building a context vector for the entire set of nodes.

12. The method of claim 1 wherein, each of the nodes includes data elements.

13. The method of claim 1 wherein, the network of nodes is distributed into groups of nodes to form the set of nodes based on identified parameters of each node so that a set of nodes exhibiting similar properties as determined by an identified parameter are grouped together.

14. The method of claim 1, wherein, the set of nodes are partitioned by a compromise line.

15. The method of claim 1, wherein, each of the sets of nodes includes at least a determined node of disagreement that is a node having the least relevance in terms of commonality based on identified parameter.

16. The method of claim 1, wherein, the network includes a plurality of set of nodes, wherein the network is a single learning map.

17. The method of claim 1, wherein, each of the sets of nodes includes at least one index selected from a creativity index, an uncertainty index, and/or a freedom index.

18. The method of claim 1, wherein, each of the nodes includes data residing on the node that is vectored in terms of parameters affecting the data.

19. The method of claim 1, wherein, each of the nodes includes data residing on the node that is vectored in terms of context affecting the data.

20. The method of claim 1, wherein, each of the nodes includes data residing on the node that is vectored in terms of a context-relevant neighboring node.

21. The method of claim 1, wherein, each of the nodes includes data on the node that is vectored in terms of an index selected from a creativity index, a freedom index, and/or an uncertainty index.

22. The method of claim 1, wherein, each of the nodes is aligned with a context-relevant neighbor node to form the set of nodes.

23. The method of claim 1, wherein, the identifying the node of disagreement includes identifying a node of disagreement for each set of nodes by identifying a difference in context-relevance per set of nodes, wherein the node of disagreement is the least relevant context-relevant node for the set of nodes.

24. A method for creating a reverse-hypothesized network including a set of nodes that is a group of context-relevant nodes each including data and parameters resident on the node using marked and considered events, the method comprising:
receiving input data residing on the nodes;
identifying a context for each node;
grouping the nodes to form a set of nodes for each context;
identifying a node of disagreement in the set of nodes by identifying a difference in context-relevance for each set of nodes;
adding stimulus data to the set of nodes to identify changes in parameters and network linkages in the set of nodes to differentiate forward hypothesis nodes and a corresponding forward hypothesized set of nodes set from reverse hypothesis nodes and a corresponding reverse hypothesized set of nodes, thereby providing inputs for obtaining an uncertainty index;
computing the uncertainty index for each set of nodes;
computing a freedom index for each set of nodes;
computing a creativity index for each set of nodes as a function of the computed uncertainty index and the computed freedom index, wherein the creativity index is a function of the uncertainty index and the freedom index; and
outputting a vector-weighted, uncertainty-weighted, freedom-weighted, and, creativity-weighted reverse-hypothesized network of nodes that is a reverse-hypothesis output.

25. A system for creating a reverse-hypothesized network including a set of nodes that is a group of context-relevant nodes each including data and parameters resident on the node using marked and considered events, the system comprising:
an inputter configured to receive input data residing on the nodes;
a computer processor configured to,
identify a context for each node,
group the nodes to form a set of nodes for each context,
identify a node of disagreement in the set of nodes by identifying a difference in context-relevance for each set of nodes,
add stimulus data to the set of nodes to identify changes in parameters and network linkages in the set of nodes to differentiate forward hypothesis nodes and a corresponding forward hypothesized set of nodes set from reverse hypothesis nodes and a corresponding reverse hypothesized set of nodes, thereby providing inputs for obtaining an uncertainty index,
compute the uncertainty index for each set of nodes,
compute a freedom index for each set of nodes,
compute a creativity index for each set of nodes as a function of the computed uncertainty index and the computed freedom index, wherein the creativity index is a function of the uncertainty index and the freedom index; and
an outputter configured to output a vectored reverse-hypothesized node, a vectored reverse-hypothesized set of nodes, or a vectored reverse-hypothesized network of sets of nodes, as a function of the creativity index.

26. The system for of claim 25, wherein, the outputter provides an output which is vector-weighted, uncertainty-weighted, freedom-weighted, and, creativity-weighted reverse-hypothesized network of nodes that is a reverse-hypothesis output.
